(19) United States
(12) Patent Application Publication
(10) Pub. No.: US 2025/0097781 A1
(43) Pub. Date: Mar. 20, 2025

(54) METHOD FOR APPLICATION MOBILITY SERVICE ACROSS MULTI-ACCESS EDGE COMPUTING

(71) Applicant: ZTE CORPORATION, Shenzhen, Guangdong (CN)

(72) Inventor: Lijuan CHEN, Shenzhen, Guangdong (CN)

(21) Appl. No.: 18/727,216

(22) PCT Filed: Feb. 17, 2022
(86) PCT No.: PCT/CN2022/076683

§ 371 Date: Jul. 8, 2024

(51) Int. Cl. H04W 36/00

(52) U.S. Cl. CPC H04W 36/0011

(57) ABSTRACT

A wireless communication method includes: receiving, by a first orchestrator from an application mobility service node, an application mobility request in response to a wireless communication terminal being out of a coverage of a source Multi-access Edge Platform, MEP; and transmitting, by the first orchestrator to a first federator, an application instance query in response to the wireless communication terminal being out of a coverage of service areas of a source Multi-access Edge Computing, MEC, system to acquire information of a target MEP and information of a target application instance in a target MEC system.

### CROSS-REFERENCE TO RELATED APPLICATION

This is a national stage application filed under 37 U.S.C. 371 based on International Patent Application No. PCT/CN2022/076683, filed on Feb. 17, 2022, the disclosure of which is incorporated herein by reference in its entirety.

### TECHNICAL FIELD

This document is directed generally to wireless communications, and in particular to 5th generation (5G) communications.

### BACKGROUND

In new radio (NR) systems, users are increasingly mobile and an increasing number of cells with smaller areas further increase a number of cell change events. When a user equipment (UE) is moved from an area of one cell to an area of another cell, service continuity is generally provided by an Application Mobility Service (AMS).

The AMS acquires information on a location of a UE from a Radio Network Information Service (RNIS). When RNIS is not deployed, the AMS cannot provide the required service to support service continuity for the application. Therefore, service continuity cannot be provided for all applications.

Another common feature of NR systems is Multi-access Edge Computing (MEC) which allows for applications with minimal latency and high availability. However, when a UE changes a location from a first MEC system to another MEC system, an MEC application cannot be continued. Service continuity for a MEC application is supported by an AMS only within a single MEC system. When a UE is moved out of the service area of the MEC system to an area of another MEC system, the AMS cannot provide the required service to support service continuity for the MEC application.

### SUMMARY

This document relates to methods for application mobility service across multi-access edge computing, devices thereof and systems thereof.

In an MEC system, the MEC federator (MEF) functional element is introduced. The MEF in a MEC system provides the functionality required to interface with MEF in other MEC systems. In this way, the MEF enables an MEC system to communicate with other MEC systems.

By providing application mobility for MEC applications across MEC systems, service continuity would be improved. This way, a mobile network provides an improved user experience.

One aspect of the present disclosure relates to a wireless communication method. In an embodiment, the wireless communication method includes: receiving, by a first orchestrator from an application mobility service node, an application mobility request in response to a wireless communication terminal being out of a coverage of a source Multi-access Edge Platform, MEP; and transmitting, by the first orchestrator to a first federator, an application instance query in response to the wireless communication terminal being out of a coverage of service areas of a source Multi-access Edge Computing, MEC, system to acquire information of a target MEP and information of a target application instance in a target MEC system.

Another aspect of the present disclosure relates to a wireless communication method. In an embodiment, the wireless communication method includes: forwarding, by a first federator from a first orchestrator to a second federator, an application instance query in response to a wireless communication terminal being out of a coverage of service areas of a source Multi-access Edge Computing, MEC, system to acquire information of a target Multi-access Edge Platform, MEP, and information of a target application instance in a target MEC system.

Another aspect of the present disclosure relates to a wireless communication method. In an embodiment, the wireless communication method includes: forwarding, by a second federator from a first federator to a second orchestrator, an application instance query in response to a wireless communication terminal being out of a coverage of service areas of a source Multi-access Edge Computing, MEC, system and the application instance query not matching registered applications on the second federator, wherein the application instance query is forwarded to acquire information of a target Multi-access Edge Platform, MEP, and information of a target application instance in a target MEC system.

Another aspect of the present disclosure relates to a wireless communication method. In an embodiment, the wireless communication method includes: receiving, by a second orchestrator from a second federator, an application instance query in response to a wireless communication terminal being out of a coverage of service areas of a source Multi-access Edge Computing, MEC, system to acquire information of a target Multi-access Edge Platform, MEP, and information of a target application instance in a target MEC system.

Another aspect of the present disclosure relates to a wireless communication method. In an embodiment, the wireless communication method includes: transmitting, by an application mobility service node to a Multi-access Edge Computing, MEC, location service node or a core network, a location subscription request to subscribe a location change of a wireless communication terminal.

Another aspect of the present disclosure relates to a wireless communication method. In an embodiment, the wireless communication method includes: forwarding, by an orchestrator from an application mobility service node to a core network, a location subscription request to subscribe a location change of a wireless communication terminal.

Another aspect of the present disclosure relates to a wireless communication node. In an embodiment, the wireless communication node includes a communication unit and a processor. The processor is configured to: receive, from an application mobility service node, an application mobility request in response to a wireless communication terminal being out of a coverage of a source Multi-access Edge Platform, MEP; and transmit, to a first federator, an application instance query in response to the wireless communication terminal being out of a coverage of service areas of a source Multi-access Edge Computing, MEC, system to acquire information of a target MEP and information of a target application instance in a target MEC system.

Another aspect of the present disclosure relates to a wireless communication node. In an embodiment, the wireless communication node includes a communication unit and a processor. The processor is configured to: forward, from a first orchestrator to a second federator, an application instance query in response to a wireless communication terminal being out of a coverage of service areas of a source Multi-access Edge Computing, MEC, system to acquire information of a target Multi-access Edge Platform, MEP, and information of a target application instance in a target MEC system.

Another aspect of the present disclosure relates to a wireless communication node. In an embodiment, the wireless communication node includes a communication unit and a processor.

The processor is configured to: forward, from a first federator to a second orchestrator, an application instance query in response to a wireless communication terminal being out of a coverage of service areas of a source Multi-access Edge Computing, MEC, system and the application instance query not matching registered applications on the second federator, wherein the application instance query is forwarded to acquire information of a target Multi-access Edge Platform, MEP, and information of a target application instance in a target MEC system.

Another aspect of the present disclosure relates to a wireless communication node. In an embodiment, the wireless communication node includes a communication unit and a processor. The processor is configured to: receive, from a second federator, an application instance query in response to a wireless communication terminal being out of a coverage of service areas of a source Multi-access Edge Computing, MEC, system to acquire information of a target Multi-access Edge Platform, MEP, and information of a target application instance in a target MEC system.

Another aspect of the present disclosure relates to a wireless communication node. In an embodiment, the wireless communication node includes a communication unit and a processor. The processor is configured to: transmit, to a Multi-access Edge Computing, MEC, location service node or a core network, a location subscription request to subscribe a location change of a wireless communication terminal.

Another aspect of the present disclosure relates to a wireless communication node. In an embodiment, the wireless communication node includes a communication unit and a processor. The processor is configured to: transmit, to a Multi-access Edge Computing, MEC, location service node or a core network, a location subscription request to subscribe a location change of a wireless communication terminal.

Various embodiments may preferably implement the following features:

Preferably, the application instance query comprises application information and location information.

Preferably, the first orchestrator is configured to receive a query result in response to the application instance query from the first federator and transmit the query result to the application mobility service node.

Preferably, the first federator is configured to receive a query result in response to the application instance query from the second federator and transmit the query result to the first orchestrator.

Preferably, the second federator is configured to receive a query result in response to the application instance query from the second orchestrator and transmit the query result to the first federator.

Preferably, the second federator is configured to transmit the query result to the first federator in response to the application instance query matching registered applications on the second federator.

Preferably, the second orchestrator is configured to transmit a query result to the second federator in response to the application instance query.

Preferably, the location subscription request comprises an identifier of the wireless communication terminal.

Preferably, the location subscription request is transmitted to the core network via an MEC Orchestrator.

Preferably, the application mobility service node is configured to receive a notification of the location change via an MEC Orchestrator.

Preferably, the orchestrator is configured to forward a notification of the location change from the core network to the application mobility service node.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF DRAWINGS

FIG. 1 shows an illustration of an information flow in an Application Mobility Service.

FIG. 2 shows a block diagram of a Multi-access Edge Computing system.

FIG. 3 shows an illustration of a message flow according to an embodiment of the present disclosure.

FIG. 4 shows an illustration of a message flow according to a further embodiment of the present disclosure.

FIG. 5 shows an illustration of a message flow according to a further embodiment of the present disclosure.

FIG. 6 shows an illustration of a message flow according to a further embodiment of the present disclosure.

FIG. 7 relates to a schematic diagram of a wireless network node 70 according to an embodiment of the present disclosure.

### DETAILED DESCRIPTION

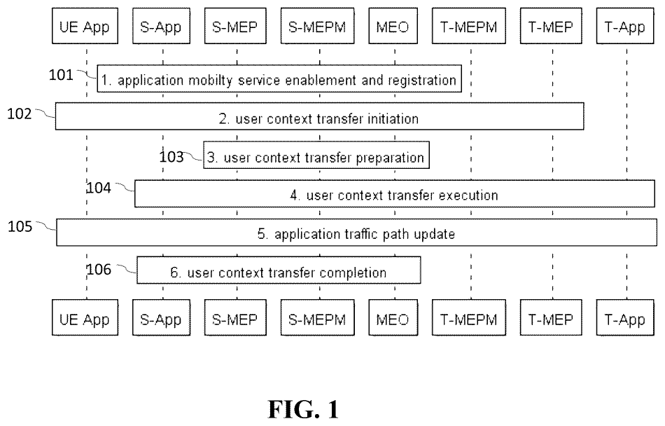

FIG. 1 illustrates an information flow in an AMS in an intra MEC system AMS scenario, in which a UE is moved from an area of one cell to an area of another cell where both cells belong to the same MEC system. The information flow is illustrated in terms of procedures, some or all of which may be present in the intra MEC system AMS scenario. The procedures contribute to transferring a user context relating to a UE application from a source application instance (S-App) running on a source MEC host to a target application instance (T-APP) running on a target MEC host. An MEC orchestrator (MEO) belonging to the MEC system may be involved in any of the procedures.

A first procedure 101 relates to application mobility service enablement and registration. This procedure includes enabling the AMS and allowing the source application to register to the AMS. The procedure may include selecting a suitable MEC host based on requirements of the application. The S-App may register directly to the AMS. The AMS may create a service ID for the S-App, which is stored in the AMS.

A further procedure 102 relates to user context transfer initiation. This procedure includes detecting and triggering mechanisms for transferring the user context to the T-App. The triggering mechanisms may include RNIS messages.

A further procedure 103 relates to user context transfer preparation. This optional procedure includes preparing a transfer of the user context to the T-App in a scenario of a MEC assisted user context transfer.

A further procedure 104 relates to user context transfer execution. This procedure includes transferring the user context to the T-App and synchronizing the user context on the T-App.

A further procedure 105 relates to an application traffic path update. This procedure includes reconfiguring a data plane to redirect traffic to the T-App on the target MEC host.

A further procedure 106 relates to a user context transfer completion. This procedure may include cleaning up the user context at the source MEC host after the user context has been transferred. Alternatively or additionally, this procedure may include cleaning up the S-App at the source MEC host after the user context has been transferred. The procedure may include deregistering the application from the AMS, for example deleting a service ID in the AMS.

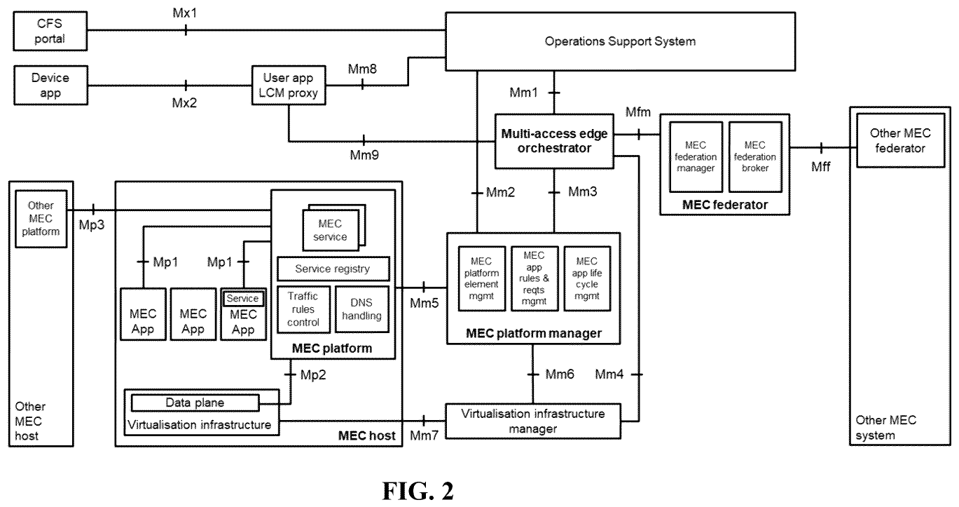

FIG. 2 illustrates a block diagram of a Multi-access Edge Computing (MEC) system. The MEC system includes an MEC host, which hosts a number of MEC Applications (MEC Apps). Further, the MEC host hosts an MEC platform (MEP), which provides MEC services and is connected to a data plane. The MEC system may include one or more further MEC hosts with further MEC platforms (MEPs). The MEC system further includes an MEC platform manager (MEPM). The MEPM provides for MEC platform element management, MEC app rules and requirements management, and MEC application life cycle management.

The MEC system further includes a Multi-access edge orchestrator, also called MEC orchestrator (MEO). The MEO provides MEC orchestration, i.e., the managing of end-to-end services or resources that were split into multiple administrative domains based on requirements and availability.

The MEC system further includes an MEC federator (MEF), which includes an MEC federation manager and an MEC federation broker. The MEF provides MEC federation, i.e., the managing of administrative relations at the interface between service orchestrators belonging to different domains and handling abstraction of services and resources. In particular, the MEC federation includes providing the functionality required the MEC system to interface with a further MEF in a further MEC system, which are also shown in FIG. 2 for illustrative purposes.

The MEC system further includes an operations support system, which provides additional services for managing and sustaining the mobile network.

RNIS (Radio Network Information Service) is used as the service of particular relevance to application mobility which provides the services of radio network information to AMS. Using RNIS, the AMS is able to query for radio information or subscribe to notifications related to special events, a particular UE, or to radio node(s) attached to the MEC host. When a specified UE moves within the underlying network and triggers a cell change event, the S-RNIS sends an RNI cell change notification that indicates the handover status of the UE. The AMS in S-MEP may correlate different notifications to determine whether the UE has moved out of the coverage area of the S-MEP. If it does, the AMS in S-MEP interact with MEO to get the information about the target application instance (T-App) on the target MEP (T-MEP). However, when RNIS is not deployed, the AMS cannot provide required service to support application service continuity.

Location Service API may be used in some embodiments. The Location Service supports the location information of specific UEs. The Location Service supports both geolocation, such as geographical coordinates, and logical location, such as a Cell ID.

In some embodiments, the 5G Core Network may expose network information and capabilities to an Edge Computing Application Function. The 5G Core network has the capability to notify MEC about the location change of a specific UE.

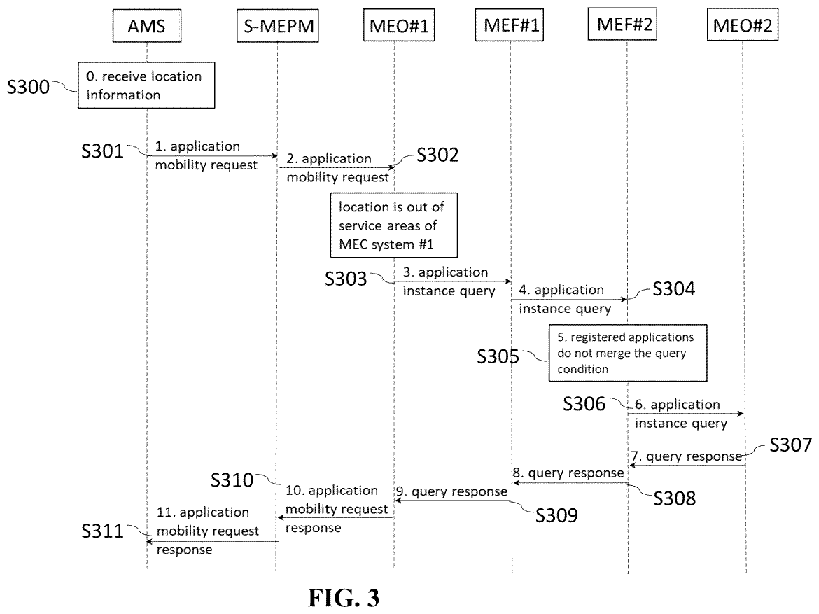

FIG. 3 illustrates a message flow according to an embodiment. The method according to the embodiment provides an application mobility service in an inter MEC system AMS scenario, in which a UE is moved from an area of one cell belonging to a first MEC system to an area of another cell belonging to a second MEC system. The information flow involves the AMS, a source MEC platform manager (S-MEPM) in the first MEC system, a first MEC orchestrator (MEO #1) belonging to the first MEC system, a first MEC federator (MEF #1) of the first MEC system, a second MEC federator (MEF #2) of the second MEC system, and a second MEC orchestrator (MEO #2) of the second MEC system. Various information messages contribute to the AMS application mobility service, some or all of which may be present in the inter MEC system AMS scenario.

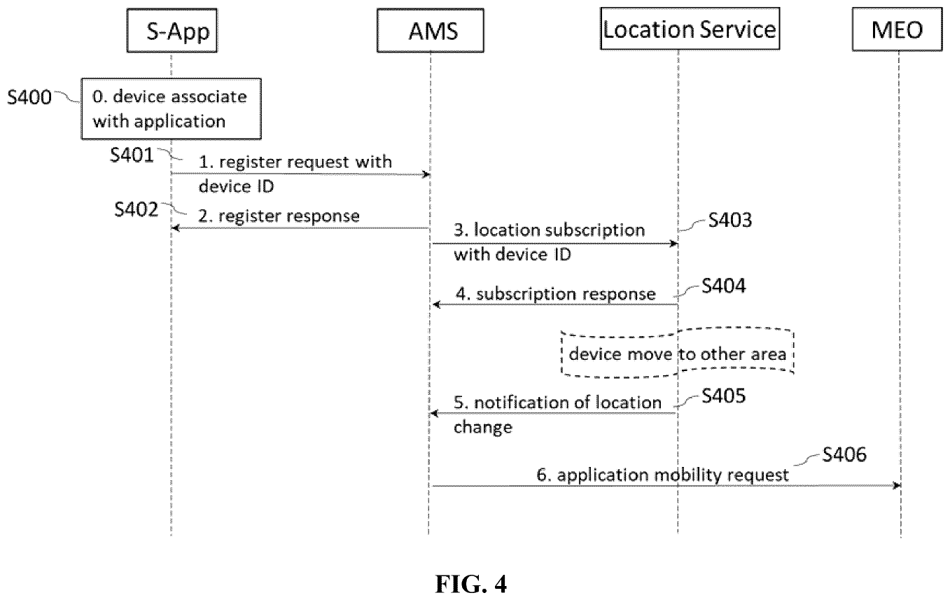

The AMS receives new location information of the UE, S300. Various cases of how the AMS may receive the device location information of the UE will be described below with reference to FIG. 4 to FIG. 6. One or more of the methods for obtaining the device location information may be available in parallel. In another example, a single one of the methods for obtaining the device location information is used.

The AMS may correlate different location information to determine whether the UE has moved out of the coverage area of the S-MEP. In this case, the AMS sends an application mobility request to the S-MEPM, S301. In turn, the S-MEPM forwards the application mobility request to the MEO #1, S302. In other words, the AMS sends the application mobility request to the MEO #1 via the S-MEPM. The application mobility request may include source application information and/or location information. In a case that the new location is in a service area covered by the first MEC system, the information flow as discussed with reference to FIG. 1 may apply. In a case that the new location is not in a service area covered by the first MEC system, the MEO #1 sends an application instance query to MEF #1, S303. The MEF #1 provides the functionality required for the first MEC system to interface with MEFs in other MEC systems. By sending the application instance query to the MEF, the application instance query may be forwarded to a host outside of the MEC system. Therefore, a user context may be transferred to a host outside of the source MEC system. MEF #1 may determine a proper MEF according to the application instance query from among the MEF available to MEF #1. MEF #1 forwards the application instance query to the MEF #2, which may be the determined proper MEF, S304.

MEF #2 determines whether the applications registered on the MEF #2 match the query conditions of the application instance query, S305. For example, the MEF #2 may determine if an application is registered on the MEF #2 which is required according to the application instance query. If the applications registered on the MEF #2 do not match the query conditions, the MEF #2 forwards the application instance query to the MEO #2, S306. In this case, MEO #2 responds with a query result to MEF #2 based on application information and location information, S307. In any case, the MEF #2 responds to the MEF #1. In the case that the MEF #2 has received a query result from the MEO #2, the MEF #2 responds to the MEF #1 with the query result from the MEO #2, S308. In the other case, when the applications registered on MEF #2 match the query conditions, the MEF #2 does not forward the application instance query to the MEO #2. In this case, the MEF #2 responds to the MEF #1 with an original query result based on application information and location information, S308. In either case, the MEF #1 responds to the MEO #1 with the query result, S309. In other words, the MEF #1 forwards the query result from the MEF #2 to the MEO #1. Finally, the MEO #1 responds to the S-MEPM with an application mobility request response, S310. The S-MEPM responds to the AMS with the application mobility request response from the MEO #1, S311. In other words, the MEO #1 sends the application mobility request response to the AMS via the S-MEPM.

A method of application mobility service according to the information flow illustrated in FIG. 3 allows for application mobility service for a MEC application in a scenario, where a UE is moved from an area of one MEC system to an area of another MEC system. This way, an improved service continuity and a mobile network with an improved user experience are provided.

The AMS may receive new location information of the UE, i.e. device location information, in various ways. In one embodiment, referring to FIG. 4, the AMS may interact with the Location Service to obtain updated device location information. When the UE associates with the S-App, the S-App receives a device ID relating to the UE, S400. The S-App sends a register request for application mobility service to the AMS, S401. The register request may include the device ID. The AMS replies to the S-App with a register response, S402. At this point, the association of the S-App and the device ID is registered at the AMS. The AMS sends a location subscription request to the Location Service, S403. The location subscription request may include the device ID. The Location Service replies to the AMS with a location subscription response, S404. The Location Service provides the functionality of locating UEs for various uses. When the UE with the specific device ID moves to another area, the Location Service sends a notification of location change to the AMS, S405. The notification of location change may include a new location of the UE. As discussed above with regard to FIG. 3, the AMS may receive different location information, such as the notification of location change, and correlate the different location information to determine whether the UE has moved out of the coverage area of the S-MEP. In this case, the AMS sends an application mobility request to the S-MEPM. The S-MEPM forwards the application mobility request to the MEO #1. In other words, the AMS sends the application mobility request to the MEO via the S-MEPM, S406. The application mobility request may include source application information and/or location information, wherein the location information is at least in part based on the notification of location change. Using the information flow according to FIG. 4, the AMS may obtain device location information without the RNIS. The method allows the AMS to subscribe to location information from the MEC Location Service. This way, the AMS may support improved service continuity, even when RNIS is not deployed. Subsequent to sending the application mobility request, the information flow may proceed according to steps or messages S302 to S311 as illustrated in FIG. 3.

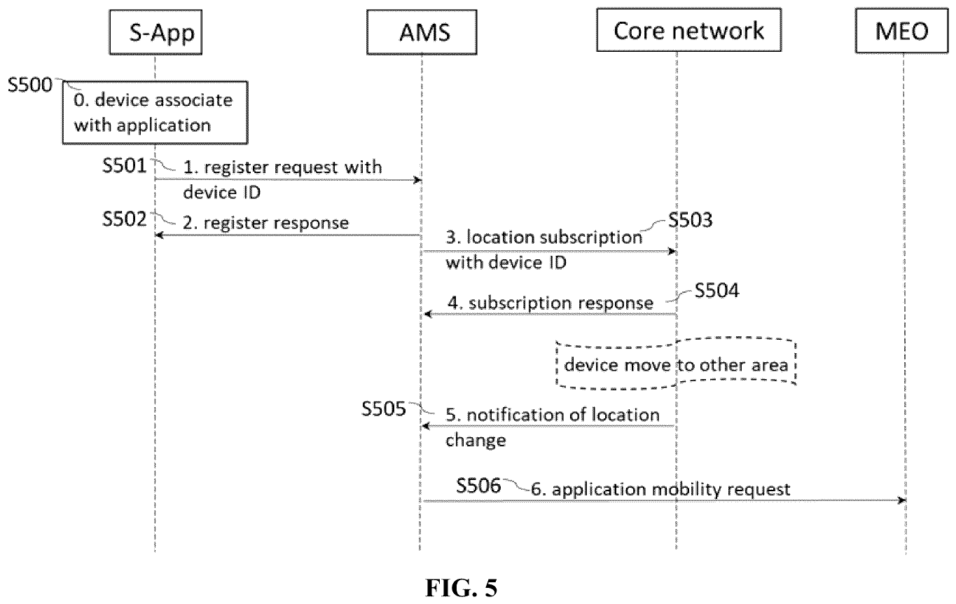

In another embodiment, referring to FIG. 5, the AMS may directly interact with the core network to obtain updated device location information. The information flow in this case may correspond to the information flow in the case illustrated in FIG. 4, with the difference that the core network takes the role of the Location Service. When the UE associates with the S-App, the S-App receives a device ID relating to the UE, S500. The S-App sends a register request for application mobility service to the AMS, S501. The register request may include the device ID. The AMS replies to the S-App with a register response, S502. The AMS sends a location subscription request to the core network, S503. The location subscription request may include the device ID. The core network replies to the AMS with a location subscription response, S504. When the UE with the specific device ID moves to another area, the core network sends a notification of location change to the AMS, S505.

The notification of location change may include a new location of the UE. As discussed above with regard to FIG. 3, the AMS may receive different location information, such as the notification of location change, and correlate the different location information to determine whether the UE has moved out of the coverage area of the S-MEP. In this case, the AMS sends an application mobility request to the S-MEPM. The S-MEPM forwards the application mobility request to the MEO #1. In other words, the AMS sends the application mobility request to the MEO via the S-MEPM, S506. The application mobility request may include source application information and/or location information, wherein the location information is at least in part based on the notification of location change.

Using the information flow according to FIG. 5, the AMS may obtain device location information without the RNIS. The method allows the AMS to subscribe to location information from the core network. This way, the AMS may support service continuity even when RNIS is not deployed. Subsequent to sending the application mobility request, the information flow may proceed according to steps or messages S302 to S311 as illustrated in FIG. 3.

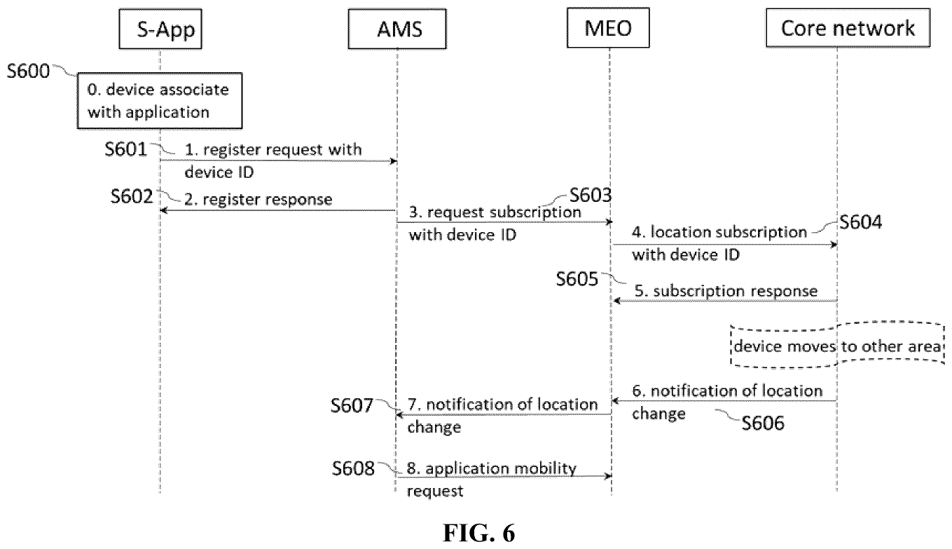

In another embodiment, referring to FIG. 6, the AMS may interact with the core network via the MEO to obtain updated device location information. When the UE associates with the S-App, the S-App receives a device ID relating to the UE, S600. The S-App sends a register request for application mobility service to the AMS, S601. The register request may include the device ID. The AMS replies to the S-App with a register response, S602. The AMS sends a location subscription request to the MEO, S603. The location subscription request may include the device ID. In other words, the AMS may send a location subscription request including a device ID to the MEO. The MEO sends a location subscription request to the core network, S604. For example, the MEO may forward the location subscription request to the core network based on the device ID from the AMS. The core network replies to the MEO with a location subscription response, S605. When the UE with the specific device ID moves to another area, the core network sends a notification of location change to the MEO, S605. The notification of location change may include a new location of the UE. The MEO sends the notification of location change to the AMS, S607. For example, the MEO may forward the notification of location change to the AMS. As discussed above with regard to FIG. 3, the AMS may receive different location information, such as the notification of location change, and correlate the different location information to determine whether the UE has moved out of the coverage area of the S-MEP. In this case, the AMS sends an application mobility request to the MEO, S606. The application mobility request may include source application information and/or location information, wherein the location information is at least in part based on the notification of location change.

Using the information flow according to FIG. 6, the AMS may obtain device location information without the RNIS. The method allows the AMS to subscribe to location information from the core network through the MEO. This way, the AMS may support improved service continuity, even when the RNIS is not deployed. Subsequent to sending S606 the application mobility request, the information flow may proceed according to steps or messages S302 to S311 as illustrated in FIG. 3.

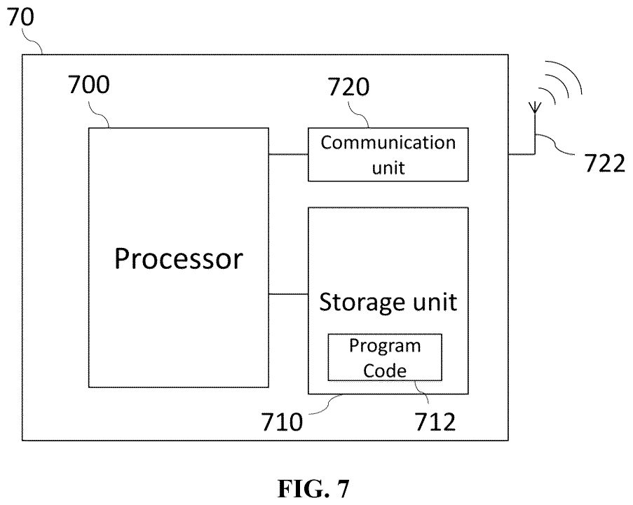

FIG. 7 relates to a schematic diagram of a wireless network node 70 according to an embodiment of the present disclosure. The wireless network node 70 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 70 may comprise (perform) at least one network function such as an access and mobility management function (AMF), a session management function (SMF), a user place function (UPF), a policy control function (PCF), an application function (AF), etc. The wireless network node 70 may include a processor 700 such as a microprocessor or ASIC, a storage unit 710 and a communication unit 720. The storage unit 710 may be any data storage device that stores a program code 712, which is accessed and executed by the processor 700. Examples of the storage unit 710 include but are not limited to a SIM, ROM, flash memory, RAM, hard-disk, and optical data storage device. The communication unit 720 may be a transceiver and is used to transmit and receive signals (e.g. messages or packets) according to processing results of the processor 700. In an example, the communication unit 720 transmits and receives the signals via at least one antenna 722 shown in FIG. 7.

In an embodiment, the storage unit 710 and the program code 712 may be omitted. The processor 700 may include a storage unit with stored program code.

The processor 700 may implement any steps described in exemplified embodiments on the wireless network node 70, e.g., via executing the program code 712.

The communication unit 720 may be a transceiver. The communication unit 720 may as an alternative or in addition be combining a transmitting unit and a receiving unit configured to transmit and to receive, respectively, signals to and from a wireless terminal (e.g. a user equipment) or another wireless network node.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium.

Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a first orchestrator from an application mobility service node, an application mobility request in response to a wireless communication terminal being out of a coverage of a source Multi-access Edge Platform, MEP; and
transmitting, by the first orchestrator to a first federator, an application instance query in response to the wireless communication terminal being out of a coverage of service areas of a source Multi-access Edge Computing, MEC, system to acquire information of a target MEP and information of a target application instance in a target MEC system.

2. The wireless communication method of claim 1, wherein the application instance query comprises application information and location information.

3. The wireless communication method of claim 1, wherein the first orchestrator is configured to receive a query result in response to the application instance query from the first federator and transmit the query result to the application mobility service node.

4. A wireless communication method comprising:
forwarding, by a first federator from a first orchestrator to a second federator, an application instance query in response to a wireless communication terminal being out of a coverage of service areas of a source Multi-access Edge Computing, MEC, system to acquire information of a target Multi-access Edge Platform, MEP, and information of a target application instance in a target MEC system.

5. The wireless communication method of claim 4, wherein the application instance query comprises application information and location information.

6. The wireless communication method of claim 4, wherein the first federator is configured to receive a query result in response to the application instance query from the second federator and transmit the query result to the first orchestrator.

7-13. (canceled)

14. A wireless communication method comprising:
transmitting, by an application mobility service node to a Multi-access Edge Computing, MEC, location service node or a core network, a location subscription request to subscribe a location change of a wireless communication terminal.

15. The wireless communication method of claim 14, wherein the location subscription request comprises an identifier of the wireless communication terminal.

16. The wireless communication method of claim 14, wherein the location subscription request is transmitted to the core network via an MEC Orchestrator.

17. The wireless communication method of claim 14, wherein the application mobility service node is configured to receive a notification of the location change via an MEC Orchestrator.

18-20. (canceled)

21. A wireless communication node, comprising:
a communication unit; and
a processor configured to perform the wireless communication method of claim 1.

22. The wireless communication node of claim 21, wherein the processor is further configured to perform the wireless communication method of claim 2.

23. A wireless communication node, comprising:
a communication unit; and
a processor configured to perform the wireless communication method of claim 4.

24. The wireless communication node of claim 23, wherein the processor is further configured to perform the wireless communication method of claim 5.

25-28. (canceled)

29. A wireless communication node, comprising:
a communication unit; and
a processor configured to perform the wireless communication method of claim 14.

30. The wireless communication node of claim 29, wherein the location subscription request comprises an identifier of the wireless communication terminal

31-32. (canceled)

33. A non-transitory computer-readable medium, comprising a computer-readable program medium code stored thereupon, the code, when executed by a processor, causing the processor to implement the wireless communication method recited in claim 1.

34. A non-transitory computer-readable medium, comprising a computer-readable program medium code stored thereupon, the code, when executed by a processor, causing the processor to implement the wireless communication method recited in claim 4.

35. A non-transitory computer-readable medium, comprising a computer-readable program medium code stored thereupon, the code, when executed by a processor, causing the processor to implement the wireless communication method recited in claim 14.

36. The wireless communication method of claim 2, wherein the first orchestrator is configured to receive a query result in response to the application instance query from the first federator and transmit the query result to the application mobility service node.
